(19) United States
(12) Patent Application Publication
(10) Pub. No.: US 2023/0278885 A1
(43) Pub. Date: Sep. 7, 2023

(54) METHODS OF PRODUCING URANIUM CHLORIDE AND COMPOSITIONS COMPRISING URANIUM CHLORIDE

(71) Applicant: Battelle Energy Alliance, LLC, Idaho Falls, ID (US)

(72) Inventors: Kenneth C. Marsden, Idaho Falls, ID (US); Kevin D. Lamont, Idaho Falls, ID (US); Michael N. Patterson, Pocatello, ID (US)

(21) Appl. No.: 18/177,414

(22) Filed: Mar. 2, 2023

Related U.S. Application Data
(60) Provisional application No. 63/268,761, filed on Mar. 2, 2022.

(51) Int. Cl. C01G 43/08

(52) U.S. Cl. CPC C01G 43/08; C01P 2006/80

(57) ABSTRACT

A method of producing uranium chloride. The method comprises combining a uranium feedstock, a chlorinating agent, and a metal salt in a reaction vessel to form a reaction mixture. The reaction mixture is heated to a temperature of from about 600° C. to about 850° C. to form uranium chloride or a uranium chloride eutectic mixture. The uranium chloride or the uranium chloride eutectic mixture is separated from the reaction mixture. A composition comprising uranium chloride or a uranium chloride eutectic mixture at a purity of greater than about 99.9 is also disclosed, as are additional methods of producing uranium chloride.

### PRIORITY CLAIM

This application claims the benefit of the filing date of U.S. Provisional Patent Application Ser. No. 63/268,761, filed Mar. 2, 2022, for “URANIUM CHLORIDE PRODUCTION,” the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

The disclosure, in various embodiments, relates generally to producing uranium chloride (UCl₃) or a UCl₃ eutectic mixture. More specifically, the disclosure, in various embodiments, relates to methods of producing UCl₃ or a UCl₃ eutectic mixture having a high purity.

### BACKGROUND

Small-scale production of uranium chloride has been achieved by complicated, multi-step processes. However, these processes utilize reactive gases and complex equipment. The reactive gases include hydrogen chloride, chlorine, carbon tetrachloride, phosgene, or similar reactants, which are present in large amounts for large-scale production. Uranium is reacted with one or more of the reactive gases to produce the uranium chloride. The uranium is finely-divided in order to have sufficient reactivity to react with the gases. The conventional processes also do not produce sufficiently pure uranium chloride because the produced uranium chloride is contaminated with starting materials.

### BRIEF DESCRIPTION OF THE DRAWING

FIG. 1 is a schematic showing a process of producing uranium chloride according to embodiments of the disclosure.

### BRIEF SUMMARY

A method of producing uranium chloride is disclosed and comprises combining a uranium feedstock, a chlorinating agent, and a metal salt in a reaction vessel to form a reaction mixture. The reaction mixture is heated to a temperature of from about 600° C. to about 850° C. to form uranium chloride or a uranium chloride eutectic mixture. The uranium chloride or the uranium chloride eutectic mixture is separated from the reaction mixture.

Another method of producing uranium chloride is disclosed and comprises combining a uranium feedstock, a transition metal chloride, and a metal salt in a reaction vessel to form a reaction mixture. The reaction mixture is heated to a temperature above a melting point of the metal salt. The uranium feedstock and the transition metal chloride are reacted at a temperature of from about 600° C. to about 850° C. to form uranium chloride or a uranium chloride eutectic mixture. The uranium chloride or the uranium chloride eutectic mixture is separated from solid components in the reaction mixture.

Also disclosed is a composition comprising uranium chloride or a uranium chloride eutectic mixture at a purity of greater than about 99.9%.

### DETAILED DESCRIPTION

Production of a fuel salt, such as a chloride-based fuel salt is disclosed. The fuel salt may be uranium chloride (e.g., uranium trichloride (UCl₃)) or a UCl₃ eutectic mixture. The uranium chloride or UCl₃ eutectic mixture formed according to embodiments of the disclosure may be formed at a large scale amount compared to conventional processes that form from 10 grams to 100 grams of uranium chloride. The uranium chloride or UCl₃ eutectic mixture formed according to embodiments of the disclosure may exhibit a purity of greater than about 99.9% and having less than about 1000 ppm of impurities. The uranium chloride or UCl₃ eutectic mixture may be produced at production scale amounts, such as from about 10,000 grams to about 20,000 grams of the uranium chloride or UCl₃ eutectic mixture per batch. Multiple batches of the uranium chloride or UCl₃ eutectic mixture may be formed to produce the desired amount of uranium chloride. A uranium feedstock is reacted with a metal salt and a chlorinating agent to produce the uranium chloride or UCl₃ eutectic mixture. The metal salt may be an alkali metal salt or an alkaline earth metal salt. The uranium chloride or UCl₃ eutectic mixture may be produced by a less complex process compared to conventional processes of forming uranium chloride. In addition, conventional equipment may be used to produce the uranium chloride or UCl₃ eutectic mixture, compared to conventional processes which utilize specialized equipment.

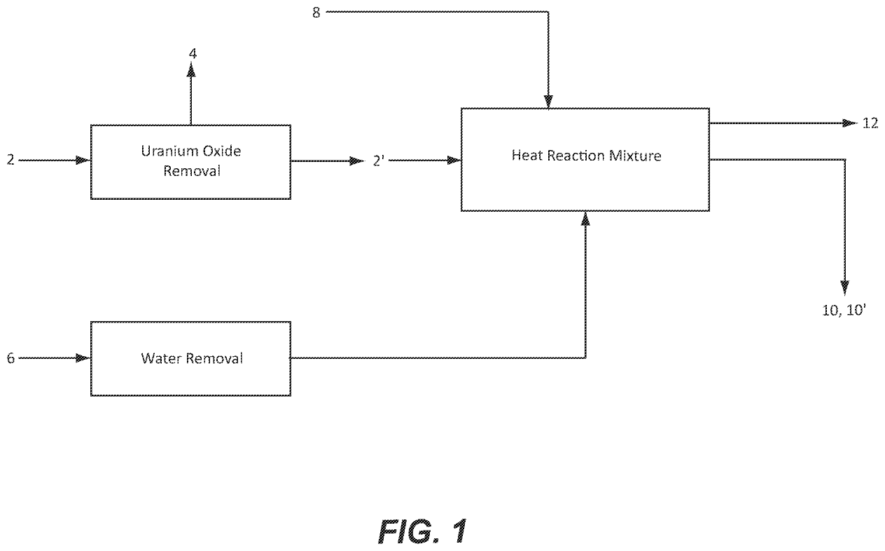

As shown in the process flow diagram of FIG. 1, a uranium feedstock 2 may be introduced (e.g., placed) into a reaction vessel. The uranium feedstock 2 may include uranium (e.g., elemental uranium) in which uranium-235 (²³⁵U) has been increased by isotope separation compared to naturally occurring uranium, which includes uranium-238 (²³⁸U), ²³⁵U, and uranium-234 (²³⁴U). By way of example only, the uranium feedstock 2 may be a highly enriched uranium (HEU) feedstock. In naturally occurring uranium, the ²³⁸U has a natural abundance of from about 99.2739% by mass to about 99.2752% by mass, the ²³⁵U has a natural abundance of from about 0.7198% by mass to about 0.7202% by mass, and the ²³⁴U has a natural abundance of from about 0.0050% by mass to about 0.0059% by mass. The uranium feedstock 2 may include depleted, natural, low-enriched, or highly enriched uranium. In a highly enriched uranium feedstock 2, the ²³⁵U fraction is present at greater than about 20% by mass. The enrichment of the ²³⁵U may be conducted by conventional techniques.

In addition to uranium (e.g., elemental uranium), the uranium feedstock 2 may include uranium oxide (UO₂) as an impurity (e.g., a contaminant). The uranium oxide may be removed from the uranium feedstock 2 by physical separation, such as by manually separating the uranium oxide, to form a purified (e.g., decontaminated) uranium feedstock 2′. The uranium oxide may be removed by subjecting the uranium feedstock 2 to a physical or chemical separation act for from about 1 hour to about 20 hours, such as from about 5 hours to about 20 hours, from about 10 hours to about 20 hours, from about 10 hours to about 15 hours, or from about 5 hours to about 15 hours. The removal of the uranium oxide from the uranium feedstock 2 may be conducted by conventional techniques. For instance, the uranium oxide may be physically removed from the uranium by brushing or may be chemically removed from the uranium by chemical cleaning. The uranium oxide may be removed using a dilute solution of nitric acid, followed by rinsing in water (e.g., deionized water), and rinsing in an organic solvent, such as acetone or methanol. A majority of the uranium oxide may be removed from the uranium feedstock 2, and uranium oxide 4 may be used or recovered as a waste stream. By way of example only, greater than about 50% of the uranium oxide may be removed from the uranium feedstock 2, such as greater than about 60% of the uranium oxide, greater than about 70% of the uranium oxide, greater than about 80% of the uranium oxide, greater than about 85% of the uranium oxide, greater than about 90% of the uranium oxide, greater than about 95% of the uranium oxide, or greater than about 99% of the uranium oxide may be removed.

The purified uranium feedstock 2′ (e.g., the feedstock having the uranium oxide substantially removed) may be introduced into the reaction vessel in a furnace. The furnace may be a conventional furnace, which is placed in an inert atmosphere environment, such as in an inert atmosphere glovebox. The reaction is conducted in the inert atmosphere environment to reduce moisture absorption by the uranium chloride or UCl₃ eutectic mixture. The furnace is compatible with (e.g., non-reactive with) uranium. A metal salt 6 and a chlorinating agent 8 are introduced to the reaction vessel along with the purified uranium feedstock 2′ to form a reaction mixture. The purified uranium feedstock 2′ may include from about 100 grams to about 15,000 grams of uranium. The purified uranium feedstock 2′ may exhibit a high surface area to be exposed to the metal salt 6, which functions as a diluent. For example, the purified uranium feedstock 2′ may be configured as uranium plates that are distributed throughout the reaction vessel, with uranium oxide removed from the uranium plates as previously described. However, the purified uranium feedstock 2′ may be configured as rods, sheets, pellets, or other shapes. To achieve a shorter reaction time, the uranium plates may be distributed in the reaction vessel so that a majority of the surfaces are exposed. The metal salt 6 and the chlorinating agent 8 are introduced to the reaction vessel and contact the purified uranium feedstock 2′, wetting the surfaces of the purified uranium feedstock 2′. Dimensions of the uranium plates may depend on a desired scale of producing the uranium chloride 10 or UCl₃ eutectic mixture 10′. By way of example only, the uranium plates may be less than or equal to about 1.5 mm in thickness to ensure substantially complete reaction between the purified uranium feedstock 2′ and the chlorinating agent 8.

The reaction mixture in the furnace is heated to a reaction temperature at or above a melting point of the metal salt 6. While the reaction temperature may be determined by the melting point of the metal salt 6, the reaction mixture may be heated to a temperature at or above a melting point of the chlorinating agent 8. For example, the melting point of LiCl—KCl is about 352° C., the melting point of NaCl is about 801° C., and the melting point of FeCl₂ is about 677° C. The reaction mixture may be heated slowly to the lowest reaction temperature sufficient to melt the metal salt 6 within an amount of time sufficient to substantially limit or prevent vaporization of the reactants or products. By way of example only, the reaction mixture may be heated at a rate of from about 5 degrees C. per minute to about 10 degrees C. per minute. To reduce vaporization, the reaction vessel may also include a cover or be otherwise enclosed. By way of example only, the reaction mixture may be heated in the furnace to the reaction temperature of from about 600° C. to about 850° C., such as from about 600° C. to about 800° C., from about 700° C. to about 850° C., from about 750° C. to about 850° C., from about 800° C. to about 850° C., from about 810° C. to about 850° C., from about 810° C. to about 840° C., from about 810° C. to about 830° C., from about 805° C. to about 825° C., from about 815° C. to about 825° C., from about 790° C. to about 850° C., from about 800° C. to about 850° C., from about 810° C. to about 850° C., from about 810° C. to about 840° C., from about 810° C. to about 830° C., from about 805° C. to about 825° C., or from about 815° C. to about 825° C. The reaction temperature may also be greater than a eutectic temperature of the resulting uranium chloride 10 or UCl₃ eutectic mixture 10′, such as from about 420° C. to about 550° C. In some embodiments, the reaction mixture is heated to a reaction temperature of about 820° C. As the metal salt 6 becomes a liquid, the chlorinating agent 8 dissolves and reacts with the uranium in the purified uranium feedstock 2′.

The reaction vessel may be a vessel configured to conduct the reaction without producing byproducts of a material of the reaction vessel. In other words, the reaction vessel may be formed of a substantially inert material. To reduce possible sources of contamination, the reaction vessel may be formed of stainless steel or other substantially inert material. Alternatively, the material of the reaction vessel may be formed of the same transition metal as a transition metal of the chlorinating agent 8 (e.g., a transition metal chloride) being used. The reaction vessel may, for example, be a commercially available stainless steel or iron container or a commercially available stainless steel or iron beaker. For instance, if the chlorinating agent 8 is iron (II) chloride, the reaction vessel may, for example, be formed of iron or an iron compound. Mesh layers may optionally be present at the bottom of the reaction vessel to remove (e.g., filter) solid components from the reaction mixture following the reaction. The mesh may have a small (e.g., fine) mesh size to remove the solid components. The mesh may, for example, be formed of the same metal as the reaction vessel, such as stainless steel, iron, or an iron compound. The reaction vessel may also include one or more openings (e.g., a drain, a valve) for separating uranium chloride 10 or UCl₃ eutectic mixture 10′, as liquids, from solid components produced during the reaction. Alternatively, one or more openings may be formed (e.g., drilled) in the reaction vessel following substantial completion of the reaction. The uranium chloride 10 or UCl₃ eutectic mixture 10′ may be poured, drained, or otherwise removed from the reaction vessel.

An alkali metal salt or an alkaline earth metal salt may be used as the metal salt 6. The metal salt 6 may be a solid at room temperature (from about 20° C. to about 25° C.) and a liquid at a temperature above the reaction temperature. The metal salt 6 may include, but is not limited to, sodium chloride (NaCl), potassium chloride (KCl), lithium chloride (LiCl), magnesium chloride (MgCl₂), a combination thereof, or a eutectic mixture thereof. In some embodiments, the metal salt 6 is NaCl. In other embodiments, the metal salt 6 is a LiCl—KCl eutectic mixture. In yet other embodiments, the metal salt 6 is a NaCl—MgCl₂ eutectic mixture. The metal salt 6 used in the reaction exhibits a high purity, such as a purity of greater than about 98%, or greater than or equal to about 99%. For instance, the metal salt 6 may exhibit a purity of greater than or equal to about 99.5%, greater than or equal to about 99.9%, greater than or equal to about 99.95%, greater than or equal to about 99.99%, or greater than or equal to about 99.999%. The high purity metal salt 6 may be commercially available from numerous sources. By using the metal salt 6 at a high purity, impurities in the resulting uranium chloride 10 or UCl₃ eutectic mixture 10′ may be decreased. For instance, the presence of high thermodynamic stability chlorides, such as calcium chloride or potassium chloride, in the uranium chloride 10 or UCl₃ eutectic mixture 10′ may be reduced.

Before the purified uranium feedstock 2′, the metal salt 6, and the chlorinating agent 8 are combined, the metal salt 6 may be dried to form a substantially anhydrous metal salt 6. The metal salt 6 may be dried under a vacuum to form the substantially anhydrous metal salt 6. The water removal may be conducted by conventional techniques. Removing the water from the metal salt 6 substantially reduces or prevents the formation of metal hydroxides and/or metal oxides during the reaction, such as alkali metal hydroxides, alkali earth metal hydroxides, alkali metal oxides, alkali earth metal oxides, and/or uranium oxide. If, for example, LiCl is used as the metal salt 6, lithium hydroxide and lithium oxide may be formed if the metal salt 6 is not substantially anhydrous. By way of example only, the metal salt 6 may be heated to a temperature of about 400° C. under a vacuum for an amount of time sufficient to evaporate substantially all of the water from the metal salt 6. By way of example only, the metal salt 6 may be heated for from about 1 hour to about 10 hours, such as from about 1 hour to about 8 hours, from about 1 hour to about 6 hours, from about 2 hours to about 10 hours, from about 2 hours to about 8 hours, to form the substantially anhydrous metal salt 6.

The chlorinating agent 8 functions as a chloride source and may be a metal chloride compound that exhibits a low vapor pressure. The chlorinating agent 8 may be a solid at room temperature (from about 20° C. to about 25° C.). The chlorinating agent 8 may, for example, be a transition metal chloride. The transition metal chloride may exhibit properties of being noble compared to uranium in the electrochemical (a low reduction potential) properties, etc. The chlorinating agent 8 may be a crystalline form of the transition metal chloride. In some embodiments, the chlorinating agent 8 is iron (II) chloride (FeCl₂), which is commercially available from numerous sources. However, other transition metal chlorides may be used, such as a chloride of nickel, chromium, cobalt, copper, manganese, zinc, bismuth, tin, cadmium, or a combination thereof.

A slight excess (e.g., stoichiometric excess) of uranium in the purified uranium feedstock 2′ may be present in the reaction mixture relative to the chlorinating agent 8 to reduce chlorine-containing contaminants in the resulting uranium chloride (e.g., UCl₃). By including a stoichiometric excess of uranium, chlorine-containing contaminants in the resulting uranium chloride may be minimal. The excess of uranium may be on the order of from about 1% to about 5% more than is used for chemical stoichiometry to ensure substantially all of the transition metal chloride is removed (e.g., reacted). By adjusting the relative amounts of the uranium, the chlorinating agent 8, and the metal salt 6, a desired composition of the UCl₃ or UCl₃ eutectic mixture may be obtained. For instance, substantially pure UCl₃ may be produced or a UCl₃ eutectic mixture may be produced. The UCl₃ eutectic mixture may be a eutectic mixture that includes the UCl₃ and the metal salt, such as a UCl₃—NaCl eutectic mixture, a UCl₃—LiCl eutectic mixture, a UCl₃—KCl eutectic mixture, a UCl₃—LiCl—KCl eutectic mixture, or a UCl₃—MgCl₂ eutectic mixture. In some embodiments, the UCl₃ eutectic mixture is a UCl₃—NaCl eutectic mixture. The UCl₃ eutectic mixture has a carrier salt that corresponds to the metal salt 6 and may include from about 70% by weight to about 75% by weight of the UCl₃.

The substantially anhydrous metal salt 6 and the chlorinating agent 8 may be added to the purified uranium feedstock 2′ to form the reaction mixture. By way of example only, the metal salt 6 may be NaCl, LiCl, KCl, MgCl₂, or a LiCl—KCl eutectic mixture and the chlorinating agent 8 may be iron chloride. If, for example, the chlorinating agent 8 is iron chloride and the metal salt 6 is NaCl or a LiCl—KCl eutectic mixture, the uranium chloride 10 or UCl₃ eutectic mixture 10′ is produced according to the following reaction:

$$3 {FeCl}_{2} + 2 U {⟶}^{NaCl , LiCl - KCl} \to 2 {UCl}_{3} + 3 Fe .$$

The reaction mixture may be heated in the furnace for an amount of time sufficient for the reaction to occur, such as from about 1 hour to about 36 hours. Unlike some conventional electrochemical processes, no electrical current is applied during the reaction. The reaction mixture may be heated until substantial completion of the reaction is achieved. The reaction mixture may be heated from about 10 hours to about 36 hours, from about 10 hours to about 24 hours, from about 15 hours to about 36 hours, from about 15 hours to about 24 hours, from about 15 hours to about 36 hours, or from about 18 hours to about 36 hours. However, the reaction time may be shorter or longer depending on a desired scale at which the reaction is to be conducted. The metal salt 6 may become a liquid (e.g., melted) during the reaction. In some embodiments where the metal salt 6 is NaCl, the reaction mixture is heated to a temperature of about 820° C. for about 2 hours, until the metal salt 6 is a liquid.

After melting the metal salt 6 and reacting the chlorinating agent 8 with the uranium in the purified uranium feedstock 2′ at a temperature of from about 600° C. to about 850° C., the temperature in the reaction vessel may be reduced, such as to about 600° C. The reaction mixture may be maintained at the lower temperature for from about 1 hour to about 24 hours for the reaction to reach substantially full completion. This lower temperature period dwell period is possible due to the reduced melting temperature caused by formation of a eutectic composition or near eutectic composition of the uranium chloride with the metal chloride at a temperature of from about 420° C. to 550° C. Furthermore, substantial completion of the process at about 600° C. reduces potential vaporization. In some embodiments, the reaction mixture is maintained at about 600° C. for about 4 hours. The reaction mixture may then be cooled, such as to about room temperature.

After completion of the reaction, the uranium chloride 10 or UCl₃ eutectic mixture 10′ may be separated from other compounds in the reaction mixture. In addition to uranium chloride or UCl₃ eutectic mixture 10′, uranium oxide and other solid compounds (e.g., byproducts) may be present after the reaction. By way of example only, the solid compounds may include one or more metal compounds, such as iron compounds or other transition metal compounds. To separate the uranium chloride 10 or UCl₃ eutectic mixture 10′, the reaction mixture may be heated to a temperature sufficient to turn the uranium chloride 10 or UCl₃ eutectic mixture 10′ into a liquid. The liquid containing the uranium chloride or UCl₃ eutectic mixture 10′ may then easily be removed from the reaction mixture in the reaction vessel. The reaction vessel may be heated to a temperature of about 100° C. above the melting temperature of the uranium chloride 10 or UCl₃ eutectic mixture 10′, such as to a temperature of from about 420° C. to about 550° C. For instance, the uranium chloride 10 or UCl₃ eutectic mixture 10′ may be separated from solid components of the reaction mixture by filtration, such as by transferring (e.g., draining) the uranium chloride 10 or UCl₃ eutectic mixture 10′ from the reaction vessel and into a second vessel, such as a collection vessel, positioned below the reaction vessel. The uranium chloride 10 or UCl₃ eutectic mixture 10′ may be drained from the openings in the reaction vessel or poured from the reaction vessel. The collection vessel may be formed of a material that the uranium chloride 10 or UCl₃ eutectic mixture 10′ does not adhere to, enabling the uranium chloride 10 or UCl₃ eutectic mixture 10′ to be easily collected as a solid after cooling. The collection vessel may also be appropriately shaped to enable collection of the uranium chloride 10 or UCl₃ eutectic mixture 10′, such as exhibiting a conical shape. The collection vessel may be formed of the same material as the reaction vessel or may be formed from carbon or graphite. The uranium chloride 10 or UCl₃ eutectic mixture 10′ may be recovered from the collection vessel after cooling. The uranium chloride in the second vessel may be substantially pure UCl₃, a substantially pure UCl₃—metal salt, or a substantially pure UCl₃-metal salt eutectic mixture. However, the uranium chloride may include trace amounts of oxide impurities, such as uranium oxide, or other impurities. In some embodiments, the uranium chloride is a UCl₃—alkali metal salt eutectic mixture. The UCl₃ or UCl₃—metal salt eutectic mixture may be produced at a purity of about 99.95%. The UCl₃ or UCl₃—metal salt eutectic mixture may, for example, include less than about 500 parts per million (ppm) of iron (II) chloride, such as less than about 200 ppm of iron (II) chloride. The solid components, such as uranium oxide, iron compounds or other transition metal compounds, of the reaction mixture in the reaction vessel may be separated and recovered as a waste stream 12. The waste stream 12 may include residual solid reactants, off-gas byproducts, and byproducts of the reaction. The iron compounds or other transition metal compounds may form a woven mat, dendrites, or elongated crystals of the metal compounds at the bottom of the reaction vessel, which may also function to remove impurities.

Depending on the desired purity of the uranium chloride (e.g., the UCl₃ or the UCl₃—metal salt eutectic mixture), additional purification acts may be conducted on partially purified uranium chloride obtained from the second vessel. The partially purified uranium chloride may be maintained in the second vessel for an amount of time sufficient for the partially purified uranium chloride to cool, following which the partially purified uranium chloride is heated as described above, melting the uranium chloride 10 or UCl₃ eutectic mixture 10′, which is separated from additional solid components and transferred to a third vessel. By repeating the heating acts, the separating acts, and the cooling acts, the uranium chloride 10 or UCl₃ eutectic mixture 10′ may be purified to the desired purity. If the solid components include chloride-based compounds, additional uranium may be added to the second or subsequent vessel to react and form additional uranium chloride 10 or UCl₃ eutectic mixture 10′. The additional purification acts may include, but are not limited to, filtration acts, etc. The uranium chloride of the desired purity may be recovered from the third or subsequent vessel, such as by placing the UCl₃ 10 or the UCl₃ eutectic mixture 10′ in a mold and cooling (e.g., freezing) the uranium chloride 10 or the UCl₃ eutectic mixture 10′. The mold may be configured to produce the uranium chloride 10 or UCl₃ eutectic mixture 10′ as so-called “pucks” or other desired configuration. The uranium chloride or UCl₃ eutectic mixture 10′ of the desired purity may be removed from the third vessel as a solid material (e.g., the pucks), which may be sealed and stored until use.

By repeatedly and sequentially conducting the heating act, the separating act, and the cooling act, the uranium chloride 10 or UCl₃ eutectic mixture 10′ of an unexpectedly high purity is produced and recovered. It was surprising that the heating act, the separating act, and the cooling act produced the uranium chloride 10 or UCl₃ eutectic mixture 10′ at a purity of greater than about 99.95%. The uranium chloride 10 or UCl₃ eutectic mixture 10′ produced according to embodiments of the disclosure may be substantially pure UCl₃ or a substantially pure UCl₃-metal salt eutectic mixture. The uranium chloride 10 or UCl₃ eutectic mixture 10′ may be produced at a purity of about 99.95% or about 99.98%. In some embodiments, the uranium chloride 10 is a UCl₃—NaCl eutectic mixture. By way of example only, the uranium chloride 10 or UCl₃ eutectic mixture 10′ may be produced at a scale of 6 kg and a purity of about 99.95%.

By forming the uranium chloride 10 or UCl₃ eutectic mixture 10′ according to embodiments of the disclosure, no gases, such as toxic gases, are utilized. Rather, the uranium chloride 10 or UCl₃ eutectic mixture 10′ according to embodiments of the disclosure is formed from a solid starting material (e.g., the chlorinating agent) that is commercially available and less toxic than gases utilized in conventional processes. In addition, neutron moderators are not utilized. Since the reaction is conducted at a moderate temperature, such as at a temperature of less than about 1,000° C., commercially available furnaces may be used to produce the uranium chloride 10 or UCl₃ eutectic mixture 10′. The vessels in which the uranium chloride 10 or UCl₃ eutectic mixture 10′ is produced may, therefore, be relatively inexpensive, disposable, and commercially available vessels. Producing the uranium chloride 10 or UCl₃ eutectic mixture 10′ according to embodiments of the disclosure is, therefore, conducted by a less complex process than conventional processes of forming UCl₃ 10 or UCl₃ eutectic mixture 10′. The number of process acts conducted is also significantly less than the number of process acts in conventional processes of forming UCl₃. In addition, the process of forming the uranium chloride 10 or UCl₃ eutectic mixture 10′ may be significantly scaled up before handling issues or criticality limitations arise.

The fuel salt (e.g., the uranium chloride 10 or UCl₃ eutectic mixture 10′) may be used as a liquid salt (e.g., a liquid fuel) in a nuclear reactor. The nuclear reactor may be configured as a molten salt reactor, such as a molten chloride fast reactor. The fuel salt may be used as one or more of a coolant or a fuel of the nuclear reactor. The fuel salt may flow through a core of the nuclear reactor. The reactor may be configured to use about 1,000 kilograms of the fuel salt. The uranium chloride 10 or UCl₃ eutectic mixture 10′ may also be used in pyrochemical recycling operations of used nuclear fuel.

While the disclosure may be susceptible to various modifications and alternative forms, specific embodiments have been shown by way of example in the drawing and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents. Additionally, elements and features disclosed in relation to one embodiment may be combined with elements and features disclosed in relation to other embodiments of the disclosure.

What is claimed is:

1. A method of producing uranium chloride, comprising:
combining a uranium feedstock, a chlorinating agent, and a metal salt in a reaction vessel to form a reaction mixture;
heating the reaction mixture to a temperature of from about 600° C. to about 850° C. to form uranium chloride or a uranium chloride eutectic mixture; and
separating the uranium chloride or the uranium chloride eutectic mixture from the reaction mixture.

2. The method of claim 1, wherein combining a uranium feedstock, a chlorinating agent, and a metal salt comprises combining a highly enriched uranium feedstock, a transition metal chloride, and the metal salt.

3. The method of claim 1, wherein combining a uranium feedstock, a chlorinating agent, and an alkali metal salt comprises combining the uranium feedstock, iron (II) chloride, and the metal salt.

4. The method of claim 3, wherein heating the reaction mixture comprises producing the uranium chloride or the uranium chloride eutectic mixture comprising less than about 200 parts per million of iron (II) chloride.

5. The method of claim 1, wherein combining a uranium feedstock, a chlorinating agent, and a metal salt comprises combining the uranium feedstock, the chlorinating agent, and an alkali metal salt or an alkaline earth metal salt.

6. The method of claim 1, wherein combining a uranium feedstock, a chlorinating agent, and a metal salt comprises combining a highly enriched uranium feedstock, a depleted uranium feedstock, a natural uranium feedstock, or a low-enriched uranium feedstock with the chlorinating agent and the metal salt.

7. The method of claim 1, wherein combining a uranium feedstock, a chlorinating agent, and a metal salt comprises combining the uranium feedstock, the chlorinating agent, and a metal salt selected from the group consisting of sodium chloride (NaCl), potassium chloride (KCl), lithium chloride (LiCl), magnesium chloride (MgCl₂), a combination thereof, or a eutectic mixture thereof.

8. The method of claim 1, wherein heating the reaction mixture comprises producing the uranium chloride or the uranium chloride eutectic mixture at a purity of greater than about 99.9%.

9. The method of claim 1, wherein heating the reaction mixture comprises producing the uranium chloride eutectic mixture comprising a lithium chloride-potassium chloride-uranium chloride eutectic mixture.

10. The method of claim 1, wherein heating the reaction mixture comprises producing the uranium chloride eutectic mixture comprising a sodium chloride-uranium chloride eutectic mixture.

11. The method of claim 1, wherein separating the uranium chloride or the uranium chloride eutectic mixture from the reaction mixture comprises separating the uranium chloride or the uranium chloride eutectic mixture from solids in the reaction mixture.

12. The method of claim 1, wherein separating the uranium chloride or the uranium chloride eutectic mixture from the reaction mixture comprises heating the reaction mixture to form the uranium chloride or the uranium chloride eutectic mixture as a liquid.

13. A method of producing uranium chloride, comprising:
combining a uranium feedstock, a transition metal chloride, and a metal salt in a reaction vessel to form a reaction mixture;
heating the reaction mixture to a temperature above a melting point of the metal salt;
reacting the uranium feedstock and the transition metal chloride at a temperature of from about 600° C. to about 850° C. to form uranium chloride or a uranium chloride eutectic mixture; and
separating the uranium chloride or the uranium chloride eutectic mixture from solid components in the reaction mixture.

14. The method of claim 13, wherein combining a uranium feedstock, a transition metal chloride, and a metal salt comprises combining a highly enriched uranium feedstock, the metal salt, and a transition metal chloride comprising nickel chloride, chrome chloride, cobalt chloride, copper chloride, manganese chloride, zinc chloride, bismuth chloride, tin chloride, cadmium chloride, or a combination thereof.

15. The method of claim 13, wherein reacting the uranium feedstock and the transition metal chloride at a temperature of from about 600° C. to about 850° C. comprises forming a UCl₃—NaCl eutectic mixture, a UCl₃—LiCl eutectic mixture, a UCl₃—KCl eutectic mixture, a UCl₃—LiCl—KCl eutectic mixture, or a UCl₃—MgCl₂ eutectic mixture.

16. The method of claim 13, wherein separating the uranium chloride or the uranium chloride eutectic mixture from solid components in the reaction mixture comprises filtering the uranium chloride or the uranium chloride eutectic mixture from the solid components of the reaction mixture.

17. A composition comprising uranium chloride or a uranium chloride eutectic mixture at a purity of greater than about 99.9%.

18. The composition of claim 17, wherein the uranium chloride eutectic mixture comprises a eutectic mixture of uranium chloride and one or more metal salts.

19. The composition of claim 17, wherein the uranium chloride or the uranium chloride eutectic mixture exhibits a purity of greater than about 99.95%.

20. The composition of claim 17, wherein the composition comprises less than about 200 parts per million of iron chloride.
